(19) United States
(12) Patent Application Publication
(10) Pub. No.: US 2025/0027305 A1
(43) Pub. Date: Jan. 23, 2025

(54) SHOWER SYSTEM WITH DELAYED SHUTDOWN

(71) Applicant: Delta Faucet Company, Indianapolis, IN (US)

(72) Inventor: Joseph Wayne Baumgarte, Carmel, IN (US)

(21) Appl. No.: 18/769,609

(22) Filed: Jul. 11, 2024

Related U.S. Application Data
(60) Provisional application No. 63/513,906, filed on Jul. 17, 2023.

(51) Int. Cl. E03C 1/05; E03C 1/02; E03C 1/04; G05D 7/06

(52) U.S. Cl. CPC E03C 1/055; E03C 1/0408; G05D 7/0635; E03C 2001/026

(57) ABSTRACT

A shower system having a shower fitting with a discharge outlet. At least one electrically operable valve being operable to control water flow from a water supply to the shower fitting; a micro-controller with a processor in communication with the valve and controlling operation of the valve. A sensor disposed in an electrical line supplying electrical power to the valve. An electrical power storage device configured to supply electrical power to the micro-controller and the valve upon loss of electrical power. The processor being configured to detect the loss of electrical power based on signals from the sensor and, upon detecting the loss of electrical power, continues operation of the shower system for a preselected time period and, upon the expiration of the preselected time period, closes the at least one electrically operable valve thereby terminating the flow of water to the shower fitting.

### CROSS-REFERNCE TO RELATED APPLICATION

This application claims priority under 35 U.S.C. 119(e) of U.S. provisional patent application Ser. No. 63/513,906 filed on Jul. 17, 2023 entitled SHOWER SYSTEM WITH DELAYED SHUTDOWN the disclosure of which is hereby incorporated herein by reference.

### BACKGROUND

The present disclosure relates to electrically operable shower valves.

The use of electrically operable valves to control the temperature and flow of water in a shower is becoming increasingly popular.

Such electrically operable valves and related electronic control components typically obtain the electrical current needed for their operation from the electrical system of the building in which the shower is located. One issue that can arise with such systems is that the electrical system of the building may lose power. When a loss of electrical power occurs, control of the electrically operably valves will also typically be lost. If such a power loss occurs while a person is taking a shower, this could result in the valves remaining open with the user not having a way to terminate water flow.

One method for addressing such a situation is to provide a manual mechanism to operate the electrically operable valves in the absence of electrical power. See, for example, U.S. Pat. No. 7,584,898B2 to Schmitt et al., the disclosure of which is incorporated herein by reference.

The electrically controlled valves used in such a shower system may include a solenoid actuator to operate the valve. In such a system, the solenoid may include a return spring that will immediately return the solenoid to a position that closes the valve when electrical power is lost.

Other systems may include an electrical motor, e.g., a servo motor, to open and close valves. In such systems, an electrical power storage device, such as a capacitor or battery might be employed to immediately close the valve upon the loss of electrical power.

Examples of electrically operable valves and shower systems having electrically operable valves can be found in U.S. Pat. Nos. 9,988,797 B2 to Reeder et al.; 9,632,514 B2 to Marty et al.; US Pub. No. 2013/0075483 A1 to Marty et al. and U.S. Pat. No. 8,162,236 B2 to Rodenbeck et al. the disclosures of each of which are incorporated herein by reference.

While such existing systems are effective, further improvements remain desirable.

### SUMMARY

The present invention provides a digital shower system which employs a delayed shutdown in the event of electrical power loss.

The use of a delayed shutdown wherein the shower valves are automatically closed and the flow of water is terminated after the passage of a predefined period of time, e.g., one to five minutes, provides an advantageous improvement over existing systems.

The delay in automatically shutting the valve and turning off the water flow allows a person, who is in the process of taking a shower when the electrical power is lost, to rapidly complete the showering process before water flow is terminated. For example, a person might have just placed shampoo in their hair when the electrical power is lost. For systems that automatically and immediately shut off the flow of water upon the loss of electrical power this puts the user in a situation where they still need to rinse shampoo from their hair but the shower system no longer provides water flow.

While a manual override for the valves is useful, such systems add physical complexity and a purely electrically controlled system provides a greater range of physical layout and aesthetic design possibilities.

In one embodiment, the present application discloses a shower system that includes a shower fitting having a discharge outlet; at least one electrically operable valve adapted to be coupled with a water supply and in fluid communication with the shower fitting, the at least one electrically operable valve being operable to control water flow from the water supply to the shower fitting; a micro-controller including a processor in communication with the at least one electrically operable valve wherein the micro-controller controls the operation of the at least one electrically operable valve and wherein the at least one electrically operable valve and the micro-controller are adapted to be coupled with a source of electrical power; a sensor disposed in an electrical line supplying electrical power to the at least one electrically operable valve and configured to detect electrical current in the electrical line, the sensor being in communication with the micro-controller; an electrical power storage device, the electrical power storage device being coupled with the micro-controller and the at least one electrically operable valve and configured to supply electrical power to the micro-controller and the at least one electrically operable valve upon loss of electrical power from the source of electrical power; and wherein the processor is configured to detect the loss of electrical power based on signals received from the sensor and, upon detecting the loss of electrical power, continues operation of the shower system for a preselected time period and, upon the expiration of the preselected time period, closes the at least one electrically operable valve and thereby terminates the flow of water to the shower fitting.

In some embodiments, the at least one electrically operable valve comprises a first valve and a second valve, the first valve being disposed between the shower fitting and a supply of cold water and the second valve being disposed between the shower fitting and a supply of hot water.

In some embodiments, the sensor is configured to detect the voltage of the electrical current in the electrical line.

In some embodiments, the electrical power storage device comprises at least one of a capacitor, a super capacitor, a disposable battery and/or a rechargeable battery.

In some embodiments, the micro-controller includes a user interface and the preselected time period is selectable by the user.

In some embodiments, the user selects from a predefined list of options and wherein the longest delay period selectable by the user is less than a maximum delay period defined by the capacity of the electrical power storage device. In such embodiments, the user interface may be a touch sensitive display screen for displaying information to the user and receiving user input.

In some embodiments, the at least one electrically operable valve includes a solenoid actuator.

In some embodiments, the at least one electrically operable valve includes an electrical motor actuator.

In some embodiments, the processor is configured to not allow the operational setting of the at least one valve to be changed during the preselected time period following the loss of electrical power. For example, the water temperature or discharge volume could not be changed during the preselected time period if the processor is configured to not allow the operational setting of the at least one valve to be changed during the preselected time period.

In some embodiments, the processor is configured to allow the operational setting of the at least one valve to be changed during the preselected time period following the loss of electrical power. In such embodiments allowing changes during the preselected time period, the processor may be further configured to monitor a charge level of the electrical power storage device and also configured to not allow the operational setting of the at least one valve to be changed during the preselected time period following the loss of electrical power when the charge level falls below a predefined threshold.

In some embodiments, the processor is configured to return to a normal operating mode without closing the at least one electrically operable valve if the sensor detects restoration of electrical power during the preselected time period.

### BRIEF DESCRIPTION OF THE DRAWINGS

The above mentioned and other features of this invention, and the manner of attaining them, will become more apparent and the invention itself will be better understood by reference to the following description of an embodiment of the invention taken in conjunction with the accompanying drawings, wherein:

FIG. 1 is a schematic diagram of a shower system.

FIG. 2 is a flow chart showing operation of the shower system of FIG. 1.

Corresponding reference characters indicate corresponding parts throughout the several views. Although the exemplification set out herein illustrates an embodiment of the invention, in one form, the embodiment disclosed below is not intended to be exhaustive or to be construed as limiting the scope of the invention to the precise form disclosed.

### DETAILED DESCRIPTION

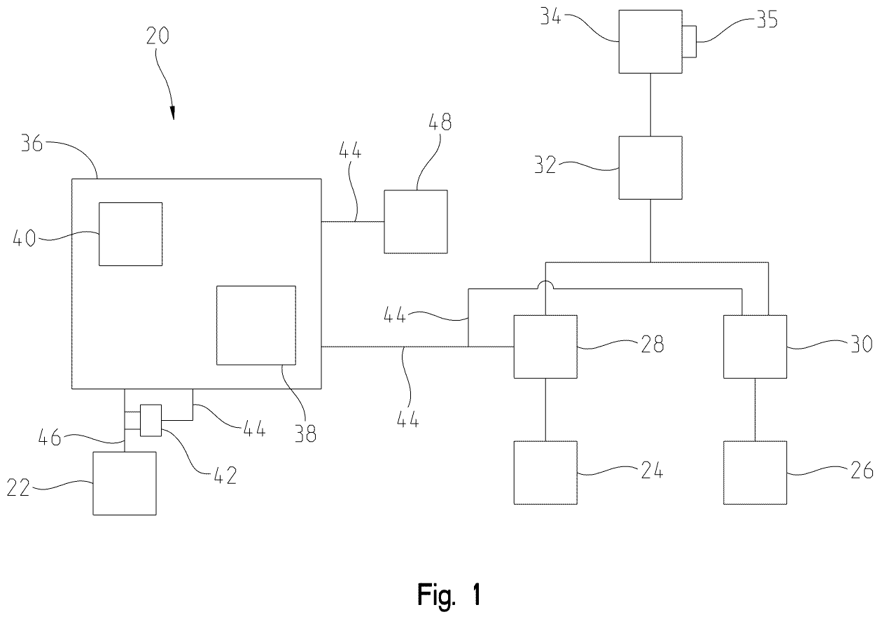

FIG. 1 shows an exemplary shower system 20 having electrically operable valves and a delayed shutdown feature whereby, if there is a loss of electrical power, the system will shut the valves and terminate the flow of water only after a preselected time period has elapsed following the loss of power to thereby allow a user a brief period of time to finish the shower after the loss of electrical power and before the system automatically closes the valves and terminates water flow.

Shower system 20 is adapted to be connected to an external source of electrical power 22 such as the existing electrical system of a building. System 20 is also adapted to be connected to a water supply. In the illustrated embodiment, system 20 is adapted to be connected to a cold water supply 24 and a hot water supply 26.

In the illustrated embodiment, electrically operable valve 28 is coupled with cold water supply 24 and electrically operable valve 30 is coupled with hot water supply 26. A mixing valve 32 combines the cold and hot water and a shower fitting 34 receives the combined water flow. Mixing valves which can be used with system 20 include those disclosed in U.S. Pat. Nos. 5,355,906 to Marty et al. and 5,725,010 to Marty et al. the disclosures of both of which are incorporated herein by reference.

Shower fitting 34 includes a discharge outlet 35 or outlets whereby the water flow is discharged for personal bathing. Shower fitting 34 may be a conventional overhead shower head or any number of alternative other shower fittings well-known in the art.

Electrically operable valves 28, 30 may be formed by any suitable form of an electrically operable valve. For example, the valves may have an actuator that opens and closes the valve that takes the form of a solenoid or an electrical motor such as a servo motor. Valves having a solenoid actuator and those having a motor actuator are well-known to those having ordinary skill in the art.

Although only a single shower fitting 34 is shown in FIG. 1, alternative embodiments may include a plurality of shower fittings. For example, in addition to a typical overhead shower discharge fitting, a mister, a steam fitting, a mid-height discharge and/or other shower fittings may be employed with system 20. When employing additional fittings, an additional number of electrically operable valves necessary to operate the additional fittings will also be employed with the system and will be subject to the same control and delayed shut-down as fitting 34 and its associated valves 28, 30. Such additional valves and fittings may be configured in a variety of different arrangements.

System 20 also includes a microcontroller 36 having a processor 38. Controller 36 is used to control the operation of system 20. The illustrated system shows only a single microprocessor 38, however, alternative embodiments may employ multiple processors or multiple control units which together or separately perform the functions described herein for controller 36.

An electrical power storage device 40 is used to provide electrical power for operating shower system 20 if the supply of electrical current from electrical power supply 22 is lost. For example, external power may be lost in extreme weather events and electrical power supply 22 may no longer supply electrical power to system 20.

Storage device 40 may take the form of any suitable electrical power storage device having the capacity to operate system 20 for a brief period of time, e.g., 1 to 5 minutes. For example, storage device 40 may take the form of one or capacitors or super capacitors having a carbon or graphene layer that allows the super capacitor to have a higher stored power density. One or more batteries, either disposable or rechargeable, may alternatively or additionally be employed. In the illustrated embodiment, super capacitors are employed as the electrical power storage device 40.

A shower system bus 44 provides for the communication of data and control signals between controller 36 and the various components of system 20. In the illustrated shower system, bus 44 includes a plurality of separate electrically conductive lines for communicating control and data signals and also includes lines for communicating electrical power. System 20 uses a serial communication protocol in accordance with the RS-485 standard to communicate signals between the various components of system 20 via bus 44. Alternative communication standards, hardware and wiring, however, may also be employed.

A sensor 42 is used to monitor the supply of electrical power from electrical power supply 22 and thereby detect the occurrence of any loss of electrical power from electrical power supply 22. In the illustrated embodiment, sensor 42 is a voltage sensor disposed in electrical supply line 46 between electrical power supply 22 and all of the electrical components of system 20 and, more specifically, controller 36. Alternative locations for sensor 42 may also be employed, provided that such locations enable sensor 42 to detect changes in the electrical current that indicate a loss of electrical power from electrical power supply 22.

When controller 36/processor 38 determines a loss of electrical power from electrical power supply 22 has occurred based upon signals received from sensor 42, or by another suitable method for detecting such power loss, controller 36 enters a shut-down mode if one or more of the electrically operable valves are open. Once entering the shut-down mode, controller 36 starts a shut-down timer and shuts all the electrically operable valves of system 20 necessary to terminate the discharge of water upon the expiration of a preselected time period thereby terminating the discharge of water through any shower fitting of system 20.

In some embodiments, processor 38 may be configured such that, if sensor 42 detects the restoration of electrical power while the system is in the shut-down mode and before the expiration of the preselected time period, i.e., the valves have not yet been closed, the shut-down mode will be aborted and the shower system will return to its normal operating mode without terminating the flow of water through shower fixture 34.

The processor may be configured to allow the operational setting of the valves 28, 30 to be changed during the preselected time period of the shut-down cycle. For example, the user may be allowed to adjust the water temperature and/or discharge volume during the preselected time period. Alternatively, the processor may be configured to lock out the operational settings of valves 28, 30 whereby such settings cannot be changed during the preselected time period of the shut-down cycle. One advantage of locking out such changes is that it will prevent such changes from unduly draining the stored energy of storage device 40 to power system 20 during the lock-down mode. In yet another alternative, controller 36 may monitor the charge level of storage device 40 and allow changes until the remaining charge of storage device 40 falls below a predefined threshold at which point no further changes to the operational settings would be permitted. The charge level of storage device 40 could be monitored by sensor 42 during the shut-down mode, or, a second voltage sensor could be employed to monitor the charge level of storage device 40.

The preselected time period which defines the time period of the delay between the loss of power and the closing of valves 28, 30 may be preselected during manufacture of system 20 and/or be selectable by the end user. The use of a user interface providing for both communication of information to the user by system 20 and input of data into system 20 by the user facilitates the selection of the preselected time period by the end user. In the illustrated embodiment, user interface 48 takes the form of a touch screen display that allows for both informational output by system 20 and user input. Alternative arrangements, including separate output and input devices, may also be employed with system 20. For example, controller 36 may include a transceiver which may communicate with a remote communications unit or the mobile phone of the end user whereby the remote communications unit or the mobile phone of the user can be used to communicate with system 20. Using user interface 48, or other suitable device, the end user may access a menu of system settings and select a time period for the shut-down mode.

Advantageously, the user is presented with a list of options and selects the desired time period from that list. For example, a range of values extending from 1 minute to 5 minutes in 30 second increments. Alternatively, the user may input a value that falls within a predefined range, e.g., any time period having a duration between 1 minute and 5 minutes which is input using numerical inputs similar to the manner in which a time period can be entered for a microwave oven.

The upper bound of the range of the preselected time periods is set so that it will be less than a maximum delay period defined by the capacity of the electrical power storage device. In other words, the upper bound of the range is selected to ensure that the storage device 40 will have a sufficient capacity to power system 20 until the end of the time period and still have sufficient power to close all of the electrically operable valves. In this regard, storage device 40 may be used to either power the entirety of system 20 or only selected components necessary to perform the delayed shut-down cycle, i.e., controller 36 and all of the electrically operable valves necessary to terminate the discharge of water. In this regard, if system 20 includes a touch screen display, it may be desirable to limit power to only controller 36 and all of the necessary electrically operable valves. If this configuration is used, it may also be desirable to prevent changing the operational settings of the electrically operable valves during the shutdown cycle because the user input device would not be powered.

It is noted, that the use of a solenoid with a return spring as the actuator for valves 28, 30 can be advantageous despite the use of a shut-down mode with system 20. While valves 28, 30 will be closed at the conclusion of the shut-down mode of system 20 in the event of a loss of electrical power from power source 22, there may still be situations where the closing of valves 28, 30 by the operation of a solenoid return spring in the absence of electrical power remains useful. For example, valves 28, 30 might lose electrical power even though electrical power source 22 is still providing electrical power due to a failure in the communication of electrical power to valves 28, 30 within system 20 such as through the failure of a bus connector or premature draining of storage device 40. In such an event, the solenoid return springs would cause the valves to close immediately upon the failure of the connector or other internal power loss.

Similarly, if electric motor actuators are used with system 20, it may be desirable for each motor actuator to be coupled with a dedicated capacitor in close physical proximity. Such a dedicated capacitor would supply power only to the motor actuator to which it was coupled and would supply the electrical power to immediately close the valve associated with the motor actuator if electrical power was lost from both external supply 22 and internal storage device 40 for reasons such as those discussed in the preceding paragraph. Manual overrides for manually closing valves 28, 30 may also be included with system 20 if such redundancy is desired.

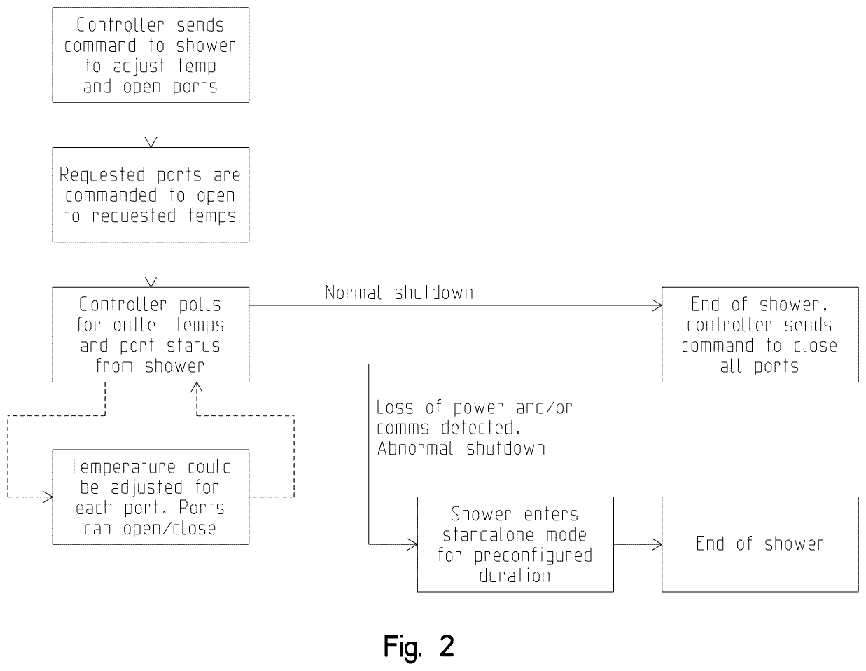

FIG. 2 provides a flow chart illustrating how one embodiment of the present invention may operate. This chart shows how a controller can be used to initiate a shower while the electrical power is still be supplied to the shower system. While FIG. 1 illustrates only a single shower fixture, the shower system disclosed herein may be used with more complex shower systems that include a plurality of fixtures for discharging water, mist and/or steam with controller 36 controlling a corresponding plurality of electrically operable valves that supply the fixtures through a plurality of corresponding valve ports. It is also noted that the flow chart of FIG. 2 assumes that the shower system allows the controller to control the temperature of the water being discharged. Such systems will also typically include temperature sensors in communication with controller to facilitate such temperature control.

If the user concludes taking a shower without experiencing a loss of electrical power, the system will enter a normal shutdown cycle as depicted in FIG. 2 and the controller will close all of the electrically operable valves to thereby terminate the discharge of water by the shower system. If, however, there is a loss of electrical power during the course of the shower, the shower system will enter a stand alone mode wherein the electrical power storage device provides the electrical power for operating the system and will remain in that shut-down mode until the expiration of the preselected time period at which point the controller will close all of the valves necessary to terminate water flow and shut down the electronic components of the system to prevent the further drawing of electrical current from the electrical power storage device. In some embodiments, the electronic components may not be fully shut-down but, instead, enter a sleep mode where only a minimal amount of electrical current is drawn from the electrical power storage device until either the electrical power storage device is fully drained or electrical power is restored.

While this invention has been described as having an exemplary design, the present invention may be further modified within the spirit and scope of this disclosure. This application is therefore intended to cover any variations, uses, or adaptations of the invention using its general principles.

What is claimed is:

1. A shower system comprising:
a shower fitting having a discharge outlet;
at least one electrically operable valve adapted to be coupled with a water supply and in fluid communication with the shower fitting, the at least one electrically operable valve being operable to control water flow from the water supply to the shower fitting;
a micro-controller including a processor in communication with the at least one electrically operable valve wherein the micro-controller controls the operation of the at least one electrically operable valve and wherein the at least one electrically operable valve and the micro-controller are adapted to be coupled with a source of electrical power;
a sensor disposed in an electrical line supplying electrical power to the at least one electrically operable valve and configured to detect electrical current in the electrical line, the sensor being in communication with the micro-controller;
an electrical power storage device, the electrical power storage device being coupled with the micro-controller and the at least one electrically operable valve and configured to supply electrical power to the micro-controller and the at least one electrically operable valve upon loss of electrical power from the source of electrical power; and
wherein the processor is configured to detect the loss of electrical power based on signals received from the sensor and, upon detecting the loss of electrical power, continues operation of the shower system for a preselected time period and, upon the expiration of the preselected time period, closes the at least one electrically operable valve and thereby terminates the flow of water to the shower fitting.

2. The shower system of claim 1 wherein the at least one electrically operable valve comprises a first valve and a second valve, the first valve being disposed between the shower fitting and a supply of cold water and the second valve being disposed between the shower fitting and a supply of hot water.

3. The shower system of claim 1 wherein the sensor is configured to detect the voltage of the electrical current in the electrical line.

4. The shower system of claim 1 wherein the electrical power storage device comprises at least one of a capacitor, a super capacitor, a disposable battery and/or a rechargeable battery.

5. The shower system of claim 1 wherein the micro-controller includes a user interface and the preselected time period is selectable by the user.

6. The shower system of claim 5 wherein the user selects from a predefined list of options and wherein the longest delay period selectable by the user is less than a maximum delay period defined by the capacity of the electrical power storage device.

7. The shower system of claim 6 wherein the user interface is a touch sensitive display screen for displaying information to the user and receiving user input.

8. The shower system of claim 1 wherein the at least one electrically operable valve includes a solenoid actuator.

9. The shower system of claim 1 wherein the at least one electrically operable valve includes an electrical motor actuator.

10. The shower system of claim 1 wherein the processor is configured to not allow the operational setting of the at least one valve to be changed during the preselected time period following the loss of electrical power.

11. The shower system of claim 1 wherein the processor is configured to allow the operational setting of the at least one valve to be changed during the preselected time period following the loss of electrical power.

12. The shower system of claim 11 wherein the processor is further configured to monitor a charge level of the electrical power storage device and is also configured to not allow the operational setting of the at least one valve to be changed during the preselected time period following the loss of electrical power when the charge level falls below a predefined threshold.

13. The shower system of claim 1 wherein the processor is configured to return to a normal operating mode without closing the at least one electrically operable valve if the sensor detects restoration of electrical power during the preselected time period.
